(19) United States
(12) Patent Application Publication
(10) Pub. No.: US 2010/0213340 A1
(43) Pub. Date: Aug. 26, 2010

(54) Standard

(76) Inventor: Maurice Lavelle Rice, Louisville, KY (US)

Correspondence Address: Maurice Rice, 808 Cecil Ave., Louisville, KY, 40211, US

(21) Appl. No.: 12/378,807

(22) Filed: Feb. 20, 2009

(51) Int. Cl. F16M 13/00; A45F 3/14

(52) U.S. Cl. 248/346.5; 224/257; 224/101

(57) ABSTRACT

The present invention comprises a lightweight portable laptop work-surface enclosed inside of a carrying-case. Metal brackets allow the carrying case to open at a 90-degree angle providing a slide-out work-surface for use of a laptop. The slide-out work-surface has eight rubber-coated metal clips that secure the laptop in a desired position. Shoulder strapping is attached to the carrying-case when the user is operating in a standing position.

### FIELD OF THE INVENTION

The present invention relates to use of laptop computers, more specifically to an attachment for portable use and stable support where seating is not available for the operator.

### BACKGROUND OF THE INVENTION AND ITS RELATION TO THE PRIOR ART

In the development of laptop computers many efforts have been sought to provide as many features as possible to accommodate the user with a small lightweight package.

The major advantage of the laptop computer is that it doesn't require a specific location for operating or even a specific surface, which advantage in turn makes possible performing work while traveling on various types of conveyances, and while waiting in terminals. However there are many situations where a person desiring to use a laptop may not have a stable or comfortable surface on which to position the laptop. Therefore in the art, other than sitting with the laptop on a desk or positioning the laptop on the lap when the person using it is in a seated position has been the principal way for a user to retain the laptop while doing work on it. Moreover seating is not always available for the user under certain circumstances, such as crowded subway-station, college campus registration lines, and stock market trade shows etc.

### SUMMARY OF THE INVENTION

The present invention is a portable carrying case for a laptop computer more specifically the invention is an enclosed slide-out work-surface for a laptop computer that provides support and stability for a laptop as the user operates from a standing position. The supporting member is a shoulder strap conveniently attachable to the lightweight carrying case that allows the user to operate a laptop from a standing position. The stability factor is a sliding clipboard for laptop, which slides outward from the concealment of the carrying case, the carrying case has two metal hinges that allows the carrying case to open to a 90-degree angle that in turn allows the sliding clipboard to be adjusted to a desired range for precision. The clipboard consists of eight rubber coated metal clips that lock a laptop in place; the clipboard also consists of four retractable miniature wheels on each bottom side of the sliding work-surface supported by two miniature wheels attached to the top inside surface of the carrying case to provide support for the work surface as it slides outward.

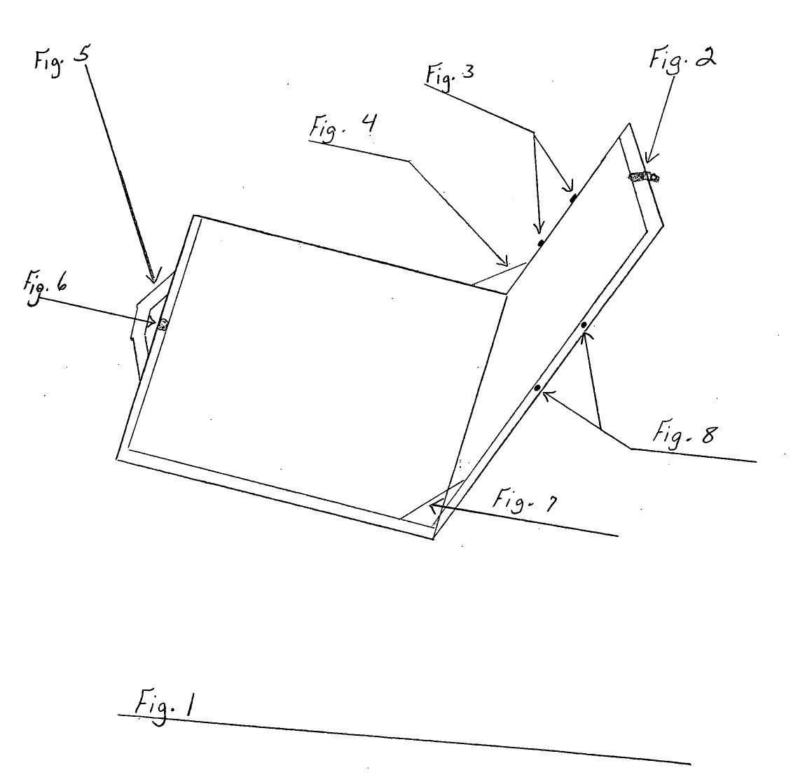

FIG. 1 Is an open view of a laptop carrying case and its assorted members.

FIG. 2 Is a front elevation displaying a flip fastener of a laptop carrying case.

FIG. 3 Is a back side elevation displaying the shoulder strap anchors of a laptop carrying case.

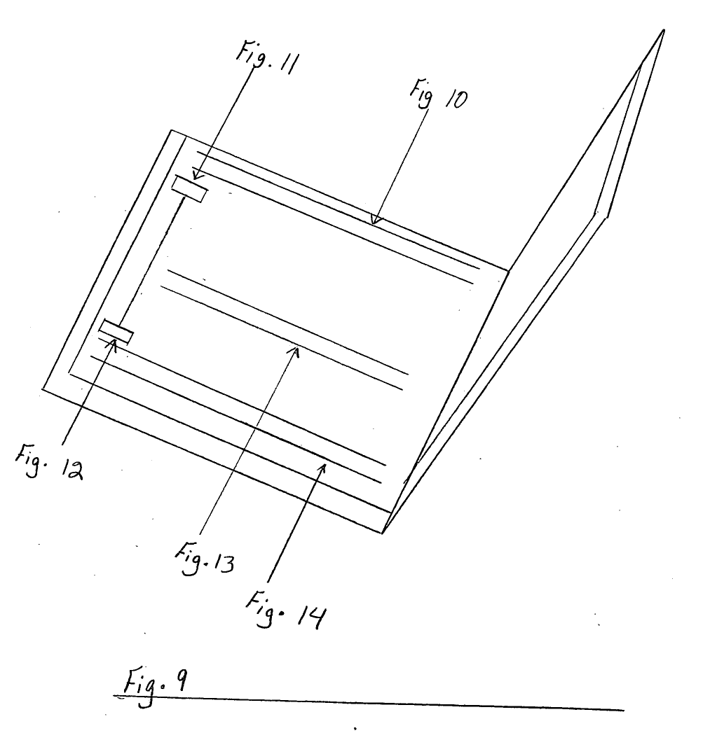

FIG. 4 Is a back side elevation displaying the hinge of a laptop carrying case that allows the carrying case to open at a ninety degree angle.

FIG. 5 Is a front elevation displaying a carrying handle of a laptop carrying case.

FIG. 6 Is a front elevation displaying a stud anchor that engages to the flip fastener of (FIG. 2).

FIG. 7 Is a front elevation displaying a hinge of a laptop carrying case that allows the carrying case to open at a ninety degree angle.

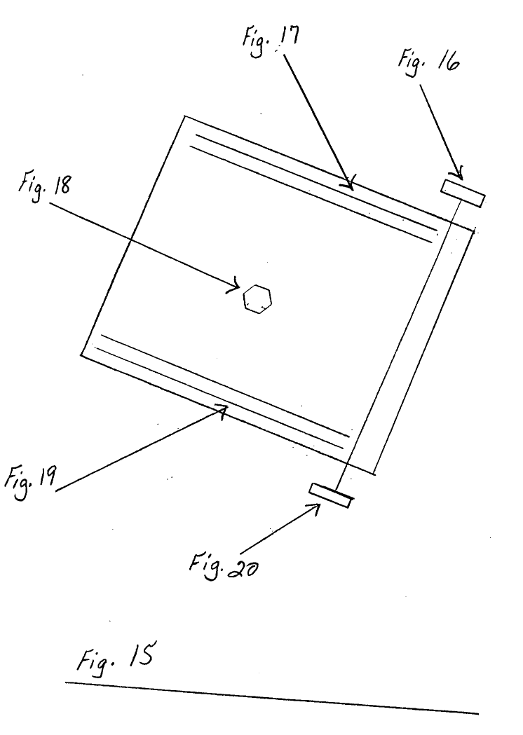

FIG. 8 Is a front elevation displaying the shoulder strap anchors of a laptop carrying case.

FIG. 9 Is an open view of a laptop carrying case and the supporting members that accommodate and secures the sliding tray.

FIG. 10 Is a front elevation displaying the outer wheel guide that directs the outer wheel of the sliding tray of the laptop carrying case.

FIG. 11 Is a front elevation displaying the inner wheel of a laptop carrying case that supports and accommodated the wheel guide of the sliding tray.

FIG. 12 Is a front elevation displaying the inner wheel of a laptop carrying case that supports and accommodates the wheel guide of the sliding tray.

FIG. 13 Is a front elevation displaying the outer wheel guide that directs the outer wheel of the sliding tray.

FIG. 14 Is a front elevation displaying the center engagement guide that accommodates the engagement lock of the sliding tray.

FIG. 15 Is a front elevation displaying the under cartridge of the sliding tray and its supporting members.

FIG. 16 Is a front elevation displaying the outer wheel that supports and directs the sliding tray of a laptop carrying case.

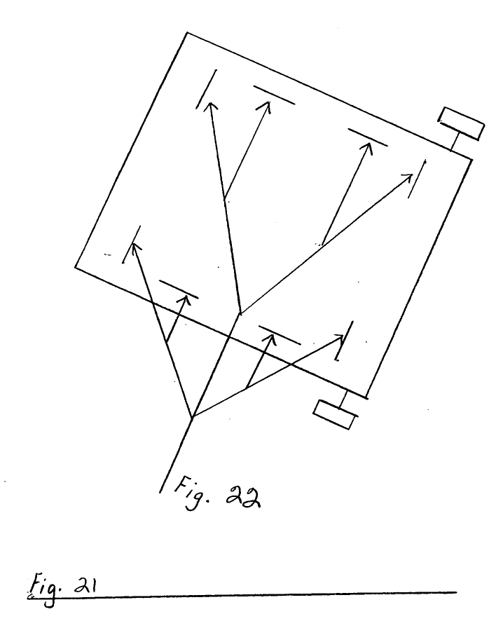

FIG. 17 Is front elevation displaying the inner wheel guide of the laptop carrying case that is supported and directed by the inner wheel of the laptop carrying case.

FIG. 18 Is a front elevation displaying the engagement lock of the sliding tray that is accommodated by the center engagement guide (FIG. 14) of the laptop carrying case.

FIG. 19 Is a front elevation displaying the inner wheel guide of the laptop carrying case that is supported and directed by the inner wheel of the laptop carrying case.

FIG. 20 Is a front elevation displaying the outer wheel that supports and directs the sliding tray of a laptop carry case.

FIG. 21 Is a front elevation of a laptop carrying case sliding tray displaying the over view (face) and its assorted members.

FIG. 22 Is a front elevation displaying the placement clamps that secure the laptop in place.

What is claimed is:

1. An attachment for a laptop comprising of a series of members: an essentially square member having and upper and lower surface, and grooves on the inside of upper and lower member that supports and accommodates a sliding flat surface which is the means for attaching the bottom surface of a laptop to the surface of said structural member in an orientation where the keyboard of the laptop is adjacent to the said front face of the said structural member. The inside member having a hinged folding portion that movable holds member to a 90 degree angle.

2. The attachment for a laptop computer of claim 1 including a shoulder strap member attached to outer surface of structural member.

3. The attachment for a laptop computer of claim 1 wherein said a sliding work surface assembly of eight rubber coated metal clip.

4. A portable laptop work surface for use securely resting on the shoulders of a user in a standing position.
